(19) United States
(12) Patent Application Publication
(10) Pub. No.: US 2010/0197434 A1
(43) Pub. Date: Aug. 5, 2010

(54) HELICAL SYNCHRONOUS BELT MADE OF URETHANE

(75) Inventor: Yuji Sekiguchi, Kobe-shi (JP)

Correspondence Address: KNOBBE MARTENS OLSON & BEAR LLP, 2040 MAIN STREET, FOURTEENTH FLOOR, IRVINE, CA, 92614, US

(73) Assignee: BANDO CHEMICAL INDUSTRIES, LTD., Kobe-shi, Hyogo (JP)

(21) Appl. No.: 12/602,067

(22) PCT Filed: May 21, 2008
(86) PCT No.: PCT/JP2008/059324

§ 371 Date: Feb. 3, 2010

(30) Foreign Application Priority Data
Jul. 2, 2007 (JP) 2007-173614

(51) Int. Cl. F16G 1/28; B29C 63/44

(52) U.S. Cl. 474/205; 264/171.1

(57) ABSTRACT

Provide a helical synchronous belt comprising a urethane resin back layer, teeth and core cords, with silicone oil attached to the teeth side, which can demonstrate sufficient durability even in the case of a narrow helical synchronous belt required by small, precision equipment, etc.

### TECHNICAL FIELD

The present invention relates to a helical synchronous belt made of urethane.

### Prior Art

The toothed belt is a meshing transmission mechanism. Impact noise occurring upon meshing of the teeth and string vibration noise from the belt are identified as the key causes of vibration and noise generated by toothed belts. The helical synchronous belt was developed for the purpose of solving these problems. Helical synchronous belts are used in a wide range of applications such as machine tools, medical devices, OA equipment, special vehicles and transporting machines, and their utilization fields are expected to widen further given the society's needs to improve the environment by reducing noise and vibration, and also to save resources and energy.

Helical synchronous belts improve noise and vibration, but they are subject to problems such as tracking and shorter life caused by inclination of helical teeth.

The applicant for the present patent had earlier proposed a helical synchronous belt designed to prevent tracking and prolong life, as described in Patent Literature 1 (Japanese Patent No. 3859640). One constituent factor that contributes to belt track is the twisted component of core cords. By focusing on the fact that changing the number of twisted core cords would reduce the tracking force, or more specifically by specifying how to twist core cords by using twist angle, the applicant proposed the aforementioned invention which is highly complete in practical applications. For example the present invention provides a helical synchronous belt for carriage drive having a twist angle of core cords opposing to the helical tooth angle, where specifically the helical tooth angle is 5° to 15° and twist angle of core cords is 15° to 2°.

### Patent Literature 1: Japanese Patent No. 3859640

### SUMMARY OF THE PRESENT INVENTION

### Problems to Be Solved by the Invention

When the coefficient of friction (against PPC paper) was measured in the Heydon test with and without degreasing the tooth surface, helical synchronous belts having a tooth angle of 0° to 12.5° had coefficients of friction ranging from 0.90 to 0.92 without degreasing, and from 1.05 to 1.20 with degreasing. A chipped-tooth durability test was conducted by driving a printer carriage back and forth using urethane toothed belts. As a result, helical synchronous belts of 0° and 7° in helical tooth angle whose tooth surface had been degreased both generated chipped teeth under 2 million cycles. On the other hand, helical synchronous belts of 0° and 7° in helical tooth angle whose tooth surface had not been degreased passed the test after 2 million cycles and even more. These results confirm that the higher the coefficient of friction at the tooth face, the shorter the life of the belt.

With belts in general, including transmission belts and timing belts, slipping of the belt has traditionally been considered a drawback because when the belt slips, transmission loss of motive power occurs or timing control becomes inaccurate. In the research & development of helical synchronous belts for incorporation into small, precision equipment, it has been difficult to pass the durability tests due to occurrence of chipped teeth and other problems. Through continuous research & development of helical synchronous belts, the applicant ventured to solve these drawbacks of conventional belts in order to meet the requirements for tight helical tooth angles. To be specific, the applicant estimated, during the research process, that friction with the pulleys would be the cause of chipped belt teeth of helical synchronous belts of tight helical tooth angles, and came up with an ingenious idea to apply lubricant on helical synchronous belts to lower their coefficients of friction. After further research & development using helical synchronous belts coated with lubricant, the applicant found that silicone oil was appropriate for this purpose and that the coating amount and viscosity were also important factors.

The present invention was developed with the aim of obtaining a helical synchronous belt offering sufficient durability, even in the case of a narrow helical synchronous belt required by small, precision equipment, etc.

### Means for Solving the Problems

The invention proposed under the present application for patent is a helical synchronous belt with silicone oil attached onto its tooth surface, in order to reduce the “slip stress” that generates as the belt meshes with the pulleys, and thereby improve durability.

The key modules incorporated into the present invention for solving the aforementioned problems are as follows:
(1) A helical synchronous belt comprising a urethane resin back layer, teeth and core cords, where said helical synchronous belt is characterized in that silicone oil is attached to the teeth side.
(2) A helical synchronous belt according to (1), characterized in that the helical tooth angle is 2° to 30°.
(3) A helical synchronous belt according to (2), characterized in that the helical tooth angle is 15° or more.
(4) A helical synchronous belt according to any one of (1) to (3), characterized in that the attached amount of silicone oil is 0.22 to 1.0 g/m².
(5) A helical synchronous belt according to any one of (1) to (4), characterized in that the viscosity of silicone oil is 1.0 to 1.0×10⁷ m²/sec at 25° C.
(6) A helical synchronous belt according to any one of (1) to (5), characterized in that said helical synchronous belt has belt width Wb, tooth pitch Ps and helical tooth angle γ and also satisfies the formula specified below:

[Formula 1] Wb×tan γ/Ps>1 (1)
(7) A helical synchronous belt according to (6), characterized in that the belt width is 2.5 mm or less, tooth pitch is 0.67 mm or less, and helical tooth angle is 15° or more.
(8) A helical synchronous belt according to any one of (1) to (7), characterized in that the twist angle of core cords opposes to the helical tooth angle.
(9) A manufacturing method for a helical synchronous belt with silicone oil attached to its teeth, consisting of coating molding dies with silicone oil, pouring liquid urethane resin into the dies and then removing the dies to manufacture a helical synchronous belt, wherein said manufacturing method is characterized in that the aforementioned silicone oil attaches to the tooth surface when the dies are removed.
(10) A manufacturing method for helical synchronous belt according to (9), characterized in that the coating amount of silicone oil on the dies is 0.45 to 2.00 g/m² and viscosity of silicone oil is 1.0 to 1.0×10⁷ m²/sec at 25° C.

### EFFECTS OF THE INVENTION

1. The present invention is a helical synchronous belt with silicone oil attached to its tooth surface, which has the effect of reducing the “slip stress” exerted, as the belt meshes with the pulleys, on the teeth through which the belt makes slip-contact with the pulleys, thereby improving the durability and wear resistance.

2. In particular, reduction of this “slip stress” decreases the degree of meshing interference between the pulley teeth and belt teeth to ensure smooth meshing, which in turn reduces the force that tracks the helical synchronous belt. As a result, it becomes possible to provide a helical synchronous belt with a larger helical tooth angle.

3. The present invention has an excellent effect in improving the durability of helical synchronous belts whose helical tooth angle is 2° or more. In particular, the present invention can contribute to the suppression of vibration, reduction of noise and improvement of durability of helical synchronous belts of narrow small pitch having a width of 2.5 mm or less and helical tooth angle of 15° or more.

4. Since silicone oil is attached to the teeth side of the helical synchronous belt at the same time when the belt is molded, no new additional process is necessary.

5. By coating the dies with silicone oil, the belt surface becomes smoother than the rough surface of the dies because silicone oil fills the gaps at the die surface when urethane is poured to mold the belt.

6. By selecting appropriate levels for the attached amount and viscosity of silicone oil, durability can be improved markedly and even a helical synchronous belt with a tight helical tooth angle of 15° or more can demonstrate enough durability to withstand practical applications.

### BRIEF DESCRIPTION OF THE DRAWINGS

FIG. 1 Schematic drawing showing the relationship of the helical tooth angle and tooth pitch of a helical synchronous belt

FIG. 2 Process chart

FIG. 3 Schematic diagram of die molding

FIG. 4 Illustration of dies

FIG. 5 Schematic diagram of tester

FIG. 6 Graph showing the relationship of how helical tooth angle affects durability at each coating amount of silicone oil

FIG. 7 Graph showing the relationship of how silicone oil affects durability at each helical tooth angle

FIG. 8 Graph showing how helical tooth angle affects durability at each viscosity of silicone oil

FIG. 9 Graph showing how viscosity of silicone oil affects durability at each helical tooth angle

FIG. 10 Example of helical synchronous belt

FIG. 11 Example showing the relationship of helical tooth angle and twist angle of core cords

### DESCRIPTION OF THE SYMBOLS

1 Pulley
2 Pulley
3 Helical synchronous belt
4 Teeth
50 Back layer
6 Core cord
7 Inner die
8 Outer die
9 Liquid elastomer of low viscosity
10 Cavity
11 Urethane sleeve
12 Dies
α Helical tooth angle
β Twist angle
G Weight
L1 Line of axial direction of pulley

### BEST MODE FOR CARRYING OUT THE INVENTION

Urethane belts are manufactured by impregnating a hardener and plasticizer into a prepolymer and then causing curing reaction. A plasticizer is added mainly to improve moldability. Once the belt is molded, plasticizer deposits on the belt surface to facilitate smooth contact between the belt and pulleys, which contributes to improved durability of the belt. However, the main purpose of using a plasticizer is to improve moldability, and thus the deposition on the belt surface is a secondary effect. Accordingly, this secondary effect of making the belt contact smoother varies significantly depending on the composition and use environment of the belt, and use of a plasticizer does not always guarantee appropriate friction characteristics.

Silicone oil is applied on the dies for the purpose of facilitating remove of the molding from the dies. When the dies are removed, silicone oil migrates and attaches to the belt surface. Since silicone oil is already attached to the belt surface in an initial manufacturing stage of the belt, the coefficient of friction of the belt can be kept to a specified level or below right after the belt is installed on the machine and starts operating.

Attaching silicone oil to a urethane belt after the belt has been manufactured adds to the number of process steps and makes uniform coating difficult. If silicone oil is not applied uniformly, problems occur that affects smooth driving of the belt. By coating the manufacturing dies with silicone oil beforehand, silicone oil spreads uniformly between the dies and urethane belt molding under the heat and high pressure in the molding step. As a result, the helical synchronous belt removed from the dies already has silicone oil uniformly attached on its teeth surface.

### (Core Material)

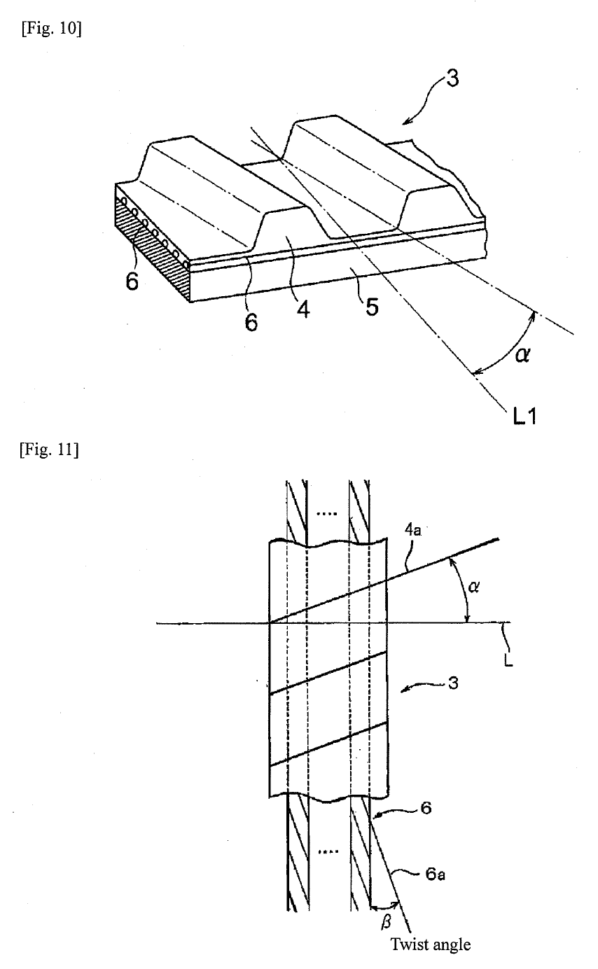

FIGS. 10 and 11 show an example of a helical synchronous belt 3 made of urethane resin. It comprises a back layer 5, teeth 4 and core cords 6, and its helical tooth angle is set to a. The back layer and teeth are molded from the same urethane resin composition which is poured into the dies. FIG. 2 shows an example of setting the helical tooth angle a and twist angle of core cords 13 in a manner opposing to each other so as to produce resistance to the tracking force. The core cords are made of a material produced by mixing aramid fibers, glass fibers, etc.

### (Application)

Among others, helical synchronous belts can be applied as driving belts and timing belts for small, precision equipment.

### (Helical Synchronous Belt)

Helical synchronous belts are used in a wide range of applications such as machine tools, medical devices, OA equipment, special vehicles and transporting machines, and their utilization fields are expected to widen further given the society's needs to improve the environment by reducing noise and vibration, and also to save resources and energy. For example, helical synchronous belts are mainly used for printers, copiers, etc., where the carriage, etc., is moved back and forth by a helical synchronous belt to determine printing positions accurately. The function of a helical synchronous belt to reduce noise and vibration is demonstrated as the pulley teeth mesh with the helical teeth, not in one shot as is the case with a spur belt, but gradually at an angle. Meshing of the next helical tooth starts before meshing of the current tooth is complete, and this mechanism is considered as a reason for the improved noise/vibration reducing function of helical synchronous belts. This meshing relationship of two adjacent teeth is determined by the tooth pitch and tooth inclination length where the wider the belt and smaller the pitch, the easier the meshings of two adjacent teeth overlap with each other. However, OA equipment, compact cameras, printers and other precision products that are becoming increasingly smaller are requiring more precise driving as well as smoother braking and damping achieved by smaller pitches. For example, these products require pitches of 1 mm or less and widths of 2.5 mm or less. As for the pitch, currently a pitch of approx. 0.67 mm is possible given the limitations on dies and other factors. At this level of pitch, the helical tooth angle must be set to 15° or more in order to achieve overlapped meshings of two adjacent teeth.

The aforementioned relationship is expressed by the schematic formula specified below.

Given a helical synchronous belt of belt width Wb, tooth pitch Ps and helical tooth angle γ, the following formula must be satisfied in order for two adjacent teeth of the helical synchronous belt to be meshing with the pulley simultaneously:

[Formula 1] Wb×tan γ/Ps>1 (1)

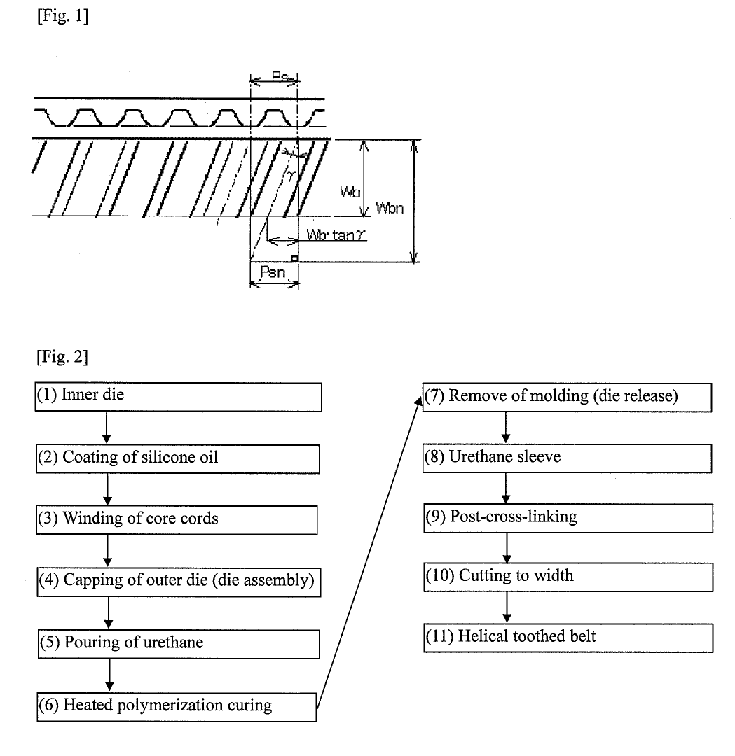

In the schematic diagram (refer to FIG. 1), the above formula holds water when the belt width is Wbn and tooth pitch is Psn. The meshings of teeth do not overlap when the belt width is Wb. Accordingly, the helical tooth angle must be increased to achieve overlapped meshings, and given the limit pitch width of 0.67 mm, the helical tooth angle γ needed to achieve a belt width of 2.5 mm is calculated as 15°.

Helical synchronous belts of 2° to 30° in helical tooth angle conforming to the present invention have been confirmed to have durability equivalent to or greater than spur belts (equal to helical tooth angle)0° with no silicone oil attached. Particularly when the helical tooth angle was set to 15° or more, the present invention provided belts that could take advantage of the unique characteristics of helical synchronous belt. When the pitch width is set to the limit of 0.67 mm and helical tooth angle to 30°, a helical synchronous belt of approx. 1.2 mm wide can be achieved.

On the other hand, increasing the helical tooth angle presents a problem in that the tracking force also increases. According to the invention proposed under the present application for patent, however, silicone oil attached to the belt surface makes the meshing of pulley teeth and belt teeth smoother, which has the reduction effect on the meshing interference level and ensures smooth meshing. Consequently, the tracking force is reduced. As a result, the present invention can support helical tooth angles of 15° or more despite Patent Literature 1 citing approx. 15° as the maximum limit of helical tooth angle in practical applications.

### (Silicone Oil)

Silicone oil used in the invention proposed under the present application for patent may be a solution of polydimethyl siloxane and hexane or methyl chloride with a viscosity of 0.50 to 10 million mm²/s, for example. Specific examples include (1) X-62-4507 with a viscosity of 4.5 million mm²/s by Shin-Etsu Chemical, (2) KF-96H-1 million cs with a viscosity of 1 million mm²/s by Shin-Etsu Chemical, (3) KF-410 with a viscosity of 900 mm²/s by Shin-Etsu Chemical, (4) TSM632 with a viscosity of 1000 mm²/s by Momentive Performance Materials Japan LLC, and (5) TSM6343 with a viscosity of 10000 mm²/s Momentive Performance Materials Japan.

The amount of silicone oil to be applied on the dies should be 0.45 to 2.00 g/m², or preferably 0.60 to 1.45 g/m², or optimally 0.91 g/m². When the dies are removeed, one half of silicone oil applied on the dies attaches to the urethane belt.

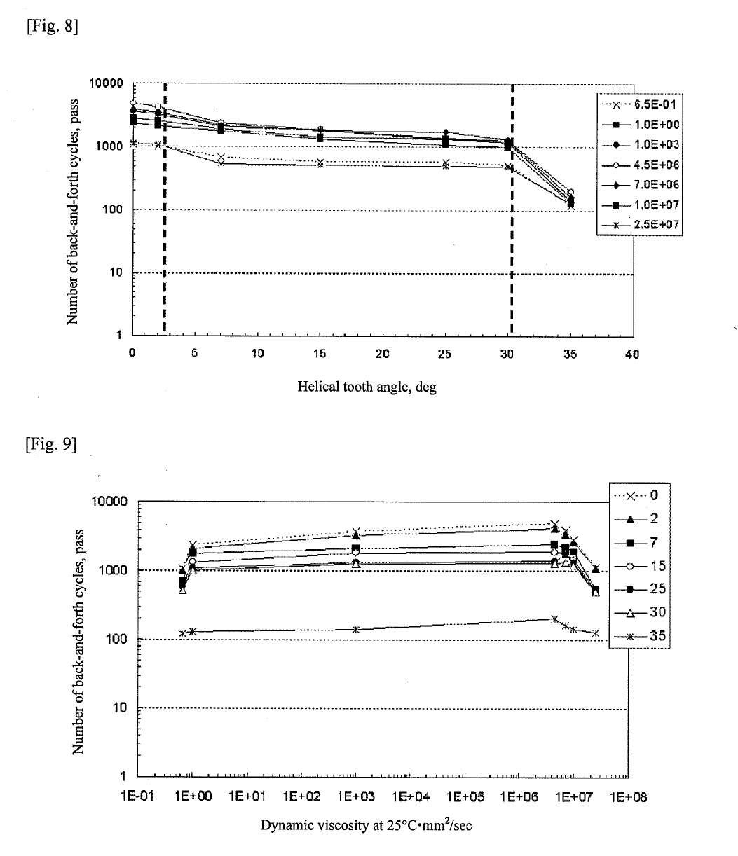

The dynamic viscosity of silicone oil should be 1.0 to 1.0×10⁷ m²/sec, or preferably 1.0 to 1.0×10⁶ m²/sec, or more preferably 4.5×10⁶ m²/sec, at normal temperature (25° C.). When the relationship with helical tooth angle was examined, marked effects were observed at helical tooth angles of within 30°. FIG. 8 shows the dynamic viscosity characteristics of silicone oil. If the dynamic viscosity of silicone oil is low, oil runs off. If the dynamic viscosity is high, on the other hand, meshing resistance between the belt and pulley increases the loss torque.

### (Method to Attach Silicone Oil)

As for the method to attach silicone oil on the belt tooth surface, an optimal method is to coat with silicone oil on the dies and allow it to migrate to the tooth surface in the course of molding and die removing, because this way silicone oil can be attached uniformly and no new additional process is required.

### (Manufacturing Method)

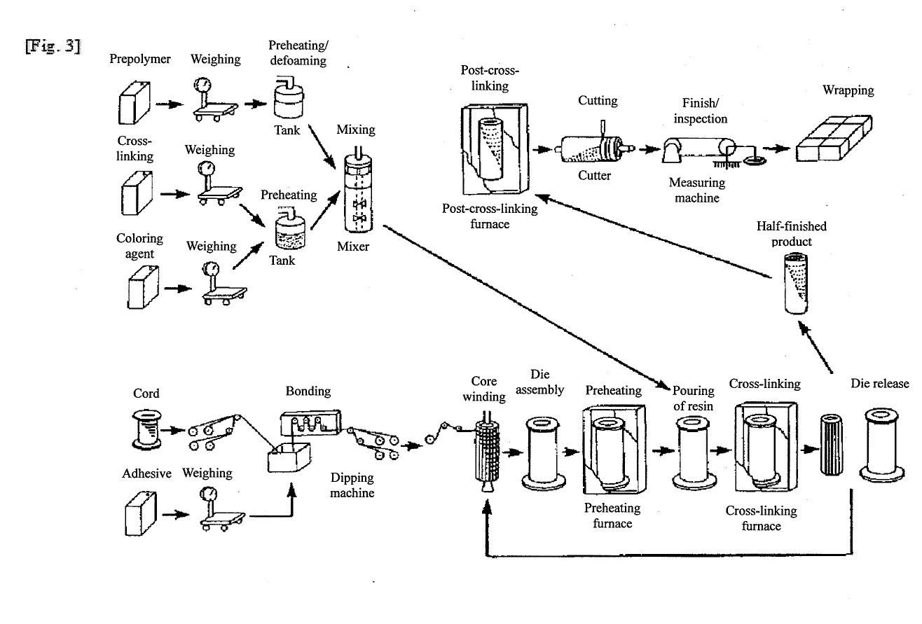

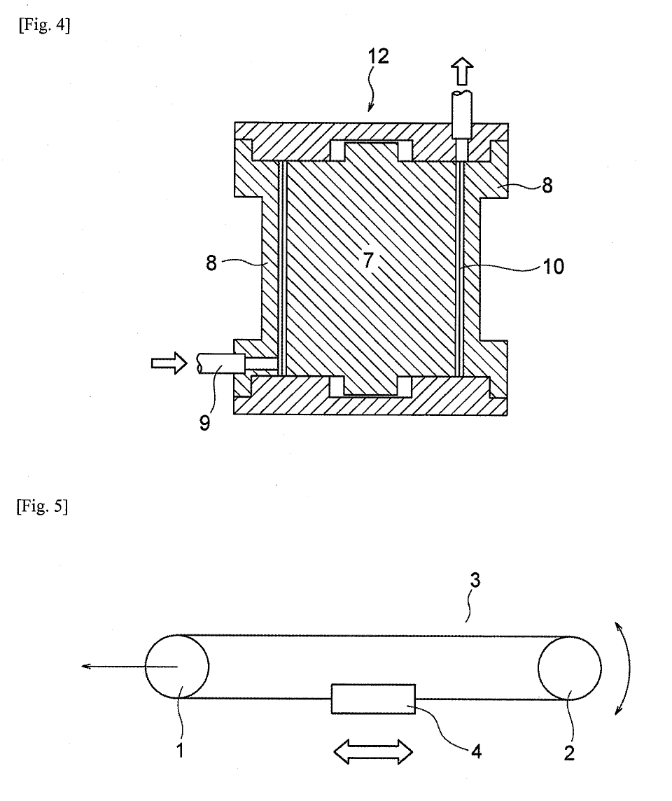

As for the manufacturing method, any standard die molding method used for manufacturing helical synchronous belts can be used. FIG. 2 shows a process chart, FIG. 3 shows a schematic diagram of die molding, and FIG. 4 is a simple illustration of dies.

The manufacturing process comprises: (1) a step to prepare an inner die which has a circumferential length corresponding to the target belt length and on which female dies corresponding to helical teeth are formed, (2) a coating step to coat with silicone oil onto the inner die using a spray, etc., (3) a core winding step to wind core cords such as twisted aramid cords around this inner die in a helical pattern, (4) an outer-die capping step to cap an outer die of cylindrical shape and assemble the dies, (5) a urethane pouring step to pour liquid urethane elastomer of low viscosity into the cavity formed by the inner die and outer die, (6) a heated polymerization step to heat the dies containing urethane to cause cross-linking and polymerization, (7) a die removing step to remove the inner die from the outer die, (8) a urethane sleeve step to remove a cylindrical urethane sleeve from the dies, (9) a post-cross-linking step to promote polymerization curing of urethane resin, and (10) a width cutting step to cut this sleeve to a desired width of helical synchronous belt, eventually providing (11) a helical synchronous belt. FIG. 3 is a schematic diagram of die molding, explaining the process illustrated in FIG. 2. A cylindrical inner die 7 is prepared and coated with silicone oil (not illustrated), after which core cords (6) are wound in a helical pattern and outer die 8 is capped, followed by die assembly, pre-heating, pouring of resin, and cross-linking, after which the dies are removed and the obtained urethane sleeve is vulcanized, post-cross-linked, and cut to width, to obtain a helical synchronous belt. FIG. 4 shows the assembled dies 12 with a cavity 10 formed between the inner die 7 and outer die 8. After the top and bottom lids are placed, liquid elastomer of low viscosity 9 is poured from the bottom edge.

### (Application and Applicability)

A helical synchronous belt obtained by the present invention can be applied, among others, as a driving belt or timing belt for small, precision equipment.

### EXAMPLES

### Example 1

Various types of urethane belts used for moving a carriage for printer, etc., back and forth were manufactured and examined by comparison.

1. Construction of Urethane Toothed Belt

4-mm in width, 1.016 mm in tooth pitch, 606.9 mm in belt length Urethane toothed belts had one of seven helical tooth angles of 0° to 35°.

2. Manufacturing Method

A standard die molding method was used. Silicone oil X-62-4507 by Shin-Etsu Chemical was applied on an inner cylindrical die on which concaves/projections to form tooth face had been formed, after which core cords were wound in a helical pattern and outer cylinder was installed, to form a cavity in which to pour resin. Next, specified liquid urethane was poured and then heated, pressurized and cured, after which the dies were removed to obtain a urethane sleeve, which was then cut to a specified width to manufacture a helical synchronous belt.

3. Silicone Oil

Silicone oil was applied on the die surface by one of seven amounts of 0 to 2.25 g/m².

The dynamic viscosity of silicone oil was selected from seven levels of 0.65 to 2.5×10⁷ m²/sec at normal temperature (25° C.).

4. Table 1 summarizes the helical tooth angles, coating amounts of silicone oil on dies and dynamic viscosities of silicone oil used in this example as specified in 1 and 3 above. Urethane toothed belts were produced by combining these conditions and evaluated.

TABLE 1

| Setting conditions for | | | | | | | | |
|---|---|---|---|---|---|---|---|---|
| examples/comparative examples | | Relationship of each parameter and number of | | | | | | |
| Parameter | Unit | back-and-forth durability cycles | | | | | | |
| Helical tooth angle | Deg | 0 | 2 | 7 | 15 | 25 | 30 | 35 |
| Coating amount of | g/m² | 0.00 | 0.45 | 0.60 | 0.91 | 1.45 | 2.00 | 2.25 |
| silicone oil | | | | | | | | |
| Viscosity of silicone oil | 25° C.-mm²/sec | 0.65 | 1 | 1000 | 4.5 * 10⁶ | 7 * 10⁶ | 1 * 10⁷ | 2.5 * 10⁷ |

5. Evaluation Method

The tester shown in FIG. 5 was used. A helical synchronous belt of each specification was passed around two-axis pulleys 1, 2 and a specified load was applied. A work G (500-g weight) simulating a printer carriage was installed on the belt in the bottom span. The driving pulley was rotated forward and backward to move the work to the left and right repeatedly. At this time, the teeth of the belt meshed around the driving pulley and received stress repeatedly, which led to fatigue of the teeth of the toothed belt and shear fracture of the teeth. Table 2 summarizes the test conditions. Tables 3 to 5 show the test results. The unit of back-and-forth cycles shown in the table is 10000.

The durability standard for carriage belt is 2 million cycles.

TABLE 2
Evaluation condition

| | |
|---|---|
| Width | 4 mm |
| Pitch | 1.016 mm |
| Pulley pitch diameter | Equivalent to approx. Ø6.625 mm |
| | 20 teeth, 12.5°: PCD Ø6.625 |
| | 20 teeth, 0°: Ø6.468 |
| Speed | 1500 rpm |
| Axial load | 9.8 N |
| Circumferential length | Equivalent to 609.6 mm |
| of belt | 600 teeth, 0°: 609.6 mm |
| | 600 teeth, 12.5°: 624.4 mm |
| Distance driven one way | 150 [mm] |
| Weight of work | 500 [gf] |
| Acceleration time | 0.15 [sec] |
| Deceleration time | 0.15 [sec] |

At this time, the teeth of the belt meshed around the driving pulley and received stress repeatedly, which led to fatigue of the teeth of the toothed belt and shear fracture of the teeth.

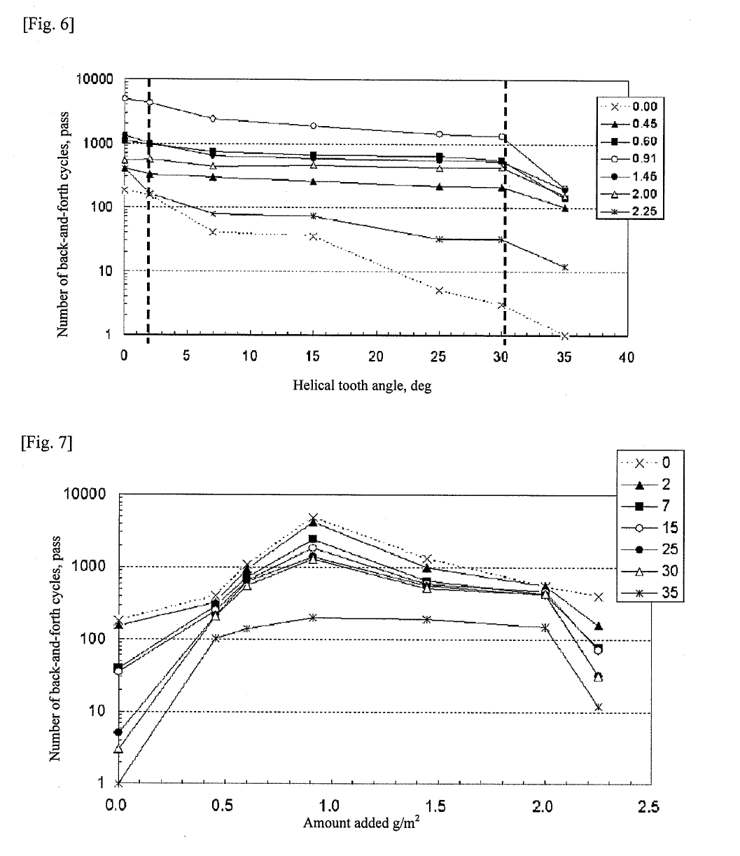

Table 3 shows the results of the durability test conducted on seven types of helical synchronous belts with helical tooth angles ranging from 0° to 35°, each produced by coating the dies with silicone oil whose viscosity had been adjusted to 4.5×10⁶ m²/sec by an amount selected from the seven levels of 0 to 2.25 g/m². The unit of cycles is “10,000 cycles.” As shown, belts of all helical tooth angles showed improved durability at coating amounts of 0.45 to 2.00 g/m² compared to the belt of 0° in helical tooth angle and 0 g/m² in coating amount of silicone oil. When the coating amount was 2.25 g/m², however, belts whose helical tooth angle was 2° or more had lower durability. These results show that coating a large amount of silicone oil is not effective in improving the durability. To illustrate this point clearly, graphs are given in FIGS. 6 and 7.

FIG. 6 is a graph of durability showing the effect of helical tooth angle at seven different coating amounts. Clearly, belts of all helical tooth angles and all coating amounts had improved durability compared to the belt with no silicone oil attached. Even when the coating amount was 0 and helical tooth angle was 0, enough durability, or 1.8 million cycles, was demonstrated to withstand practical applications. When this condition is used as the reference, durability improved at coating amounts of 0.45 to 2.00 g/m² when the helical tooth angle was 2° to 30°, but the durability was lower than the aforementioned value at all helical tooth angles when the coating amount was 2.25 g/m². In other words, simply increasing the coating amount does not necessarily lead to improved durability. The greatest durability was achieved at a coating amount of 0.91 g/m², and even at a helical tooth angle of 35° enough durability could be achieved at coating amounts of 0.91 and 1.45 g/m² to withstand practical applications.

FIG. 7 is a graph of durability showing the effect of coating amount at seven different helical tooth angles. Clearly, the durability improved at coating amounts of 0.45 to 2.00 g/m², reaching the peak at 0.91 g/m². As shown, the durability dropped as the helical tooth angle increased when the coating amount was 2.25 g/m².

TABLE 3
Durability cycles
Viscosity: 4.5 × 10⁶

| Helical tooth | Amount of silicone oil X-62-4507 added, g/m² | | | | | | |
|---|---|---|---|---|---|---|---|
| angle, deg° | 0.00 | 0.45 | 0.60 | 0.91 | 1.45 | 2.00 | 2.25 |
| 0 | 180 | 400 | 1080 | 4870 | 1320 | 538 | 400 |
| 2 | 154 | 321 | 950 | 4210 | 1003 | 560 | 159 |
| 7 | 40 | 292 | 729 | 2430 | 640 | 433 | 78 |
| 15 | 35 | 254 | 643 | 1870 | 580 | 459 | 72 |
| 25 | 5 | 218 | 630 | 1390 | 549 | 421 | 32 |
| 30 | 3 | 209 | 552 | 1300 | 520 | 428 | 32 |
| 35 | 1 | 102 | 140 | 201 | 190 | 152 | 12 |

Unit: 10,000 cycles

viscosity by focusing on the optimal coating amount of silicone oil, or 0.91 g/m². The results are shown in Table 4. FIG. 8 illustrates the results at seven viscosities in a graph. At the lowest and highest viscosities, the durability value was low at each helical tooth angle, while stably high durability was achieved at intermediate viscosities of 1 to 1×10⁷ m²/sec. The effect of helical tooth angle roughly remained flat, although dropping slightly, up to 30°, and then dropped suddenly at 35°. FIG. 9 illustrates the results at seven helical tooth angles in a graph. At six helical tooth angles of 0 to 30°, durability of 10 million cycles or more was achieved at silicone oil viscosities of 1 to 1×10⁷ m²/sec. When the helical tooth angle was 35°, durability was limited to 2 million cycles or less.

TABLE 4
Coating amount: 0.91 g/m²

| Helical | | | | | | | |
|---|---|---|---|---|---|---|---|
| tooth | | | | | | | |
| angle, | Viscosity of silicone oil at 25° C. · mm²/sec | | | | | | |
| deg | 0.65 | 1 | 1000 | 4.5 * 10⁶ | 7 * 10⁶ | 1 * 10⁷ | 2.5 * 10⁷ |
| 0 | 1082 | 2340 | 3710 | 4870 | 3847 | 2841 | 1140 |
| 2 | 1020 | 2100 | 3240 | 4210 | 3481 | 2620 | 1100 |
| 7 | 690 | 1793 | 2109 | 2430 | 2198 | 1930 | 540 |
| 15 | 590 | 1349 | 1850 | 1870 | 1842 | 1437 | 520 |
| 25 | 589 | 1102 | 1340 | 1390 | 1732 | 1349 | 510 |
| 30 | 521 | 1005 | 1282 | 1300 | 1328 | 1204 | 498 |
| 35 | 120 | 132 | 140 | 201 | 164 | 145 | 128 |

Unit: 10,000 cycles

### Example 2

The durability standard of 2 million cycles was cleared when the width was 2.5 mm, helical tooth angle was 15°, coating amount of silicone oil was 0.91 g/m², and viscosity of silicone oil was 4.5×10⁶ m²/sec.

1. A helical synchronous belt comprising a urethane resin back layer, teeth and core cords, where said helical synchronous belt is characterized in that silicone oil is attached to the teeth side.

2. The helical synchronous belt according to claim 1, characterized in that the helical tooth angle is 2° to 30°.

3. The helical synchronous belt according to claim 2, characterized in that the helical tooth angle is 15° or more.

4. The helical synchronous belt according to claim 1, characterized in that the attached amount of silicone oil is 0.22 to 1.0 g/m².

5. The helical synchronous belt according to claim 1, characterized in that the viscosity of silicone oil is 1.0 to 1.0×10⁷ mm²/sec at 25° C.

6. The helical synchronous belt according to claim 1, characterized in that said helical synchronous belt has belt width Wb, tooth pitch Ps and helical tooth angle γ and also satisfies the formula specified below:
Wb×tan γ/Ps>1 (1)

7. The helical synchronous belt according to claim 6, characterized in that the belt width is 2.5 mm or less, tooth pitch is 0.67 mm or less, and helical tooth angle is 15° or more.

8. The helical synchronous belt according to claim 1, characterized in that the twist angle of core cords opposes to the helical tooth angle.

9. A manufacturing method for a helical synchronous belt with silicone oil attached to its teeth, consisting of coating molding dies with silicone oil, pouring liquid urethane resin into the dies and then releasing the dies to manufacture a helical synchronous belt, wherein said manufacturing method is characterized in that the aforementioned silicone oil attaches to the tooth surface when the dies are removed.

10. The manufacturing method for helical synchronous belt according to claim 9, characterized in that the coating amount of silicone oil on the dies is 0.45 to 2.00 g/m² and viscosity of silicone oil is 1.0 to 1.0×10⁷ mm²/sec at 25° C.

11. The helical synchronous belt according to claim 2, characterized in that the attached amount of silicone oil is 0.22 to 1.0 g/m².

12. The helical synchronous belt according to claim 2, characterized in that the viscosity of silicone oil is 1.0 to 1.0×10⁷ mm²/sec at 25° C.

13. The helical synchronous belt according to claim 4, characterized in that the viscosity of silicone oil is 1.0 to 1.0×10⁷ mm²/sec at 25° C.

14. The helical synchronous belt according to any one of claim 2, characterized in that said helical synchronous belt has belt width Wb, tooth pitch Ps and helical tooth angle γ and also satisfies the formula specified below:
Wb×tan γ/Ps>1 (1)

15. The helical synchronous belt according to any one of claim 4, characterized in that said helical synchronous belt has belt width Wb, tooth pitch Ps and helical tooth angle γ and also satisfies the formula specified below:
Wb×tan γ/Ps>1 (1)

16. The helical synchronous belt according to any one of claim 5, characterized in that said helical synchronous belt has belt width Wb, tooth pitch Ps and helical tooth angle γ and also satisfies the formula specified below:
Wb×tan γ/Ps>1 (1)

17. The helical synchronous belt according to claim 2, characterized in that the twist angle of core cords opposes to the helical tooth angle.

18. The helical synchronous belt according to claim 4, characterized in that the twist angle of core cords opposes to the helical tooth angle.

19. The helical synchronous belt according to claim 5, characterized in that the twist angle of core cords opposes to the helical tooth angle.

20. The helical synchronous belt according to claim 6, characterized in that the twist angle of core cords opposes to the helical tooth angle.
